(19) United States
(12) Patent Application Publication
(10) Pub. No.: US 2022/0083019 A1
(43) Pub. Date: Mar. 17, 2022

(54) WORK RECEIVING APPARATUS, WORK TRANSPORT APPARATUS, INSPECTION APPARATUS, PLACEMENT SUPPORT METHOD, AND INSPECTION METHOD

(71) Applicant: SCREEN HOLDINGS CO., LTD., Kyoto (JP)

(72) Inventors: Masatoshi Shimada, Kyoto (JP); Mei Zhang, Kyoto (JP)

(21) Appl. No.: 17/399,850

(22) Filed: Aug. 11, 2021

(30) Foreign Application Priority Data
Sep. 15, 2020 (JP) 2020-154400

(51) Int. Cl. G05B 19/402; G05B 19/401; B25J 9/16; G05B 19/418; G06T 7/00

(52) U.S. Cl. CPC G05B 19/402; G05B 19/401; G06T 7/74; G05B 19/4189; G06T 7/001; B25J 9/1697

(57) ABSTRACT

A work receiving apparatus according to the present invention comprises a stage which includes an upper surface serving as a placement surface on which a work having a predetermined shape can be placed, and a projection part which is provided above the placement surface and projects a guide image on the placement surface to guide a placement position of the work on the placement surface. The guide image includes an image corresponding to a shape and an appropriate posture of the work on the placement surface. It is possible to eliminate the need to prepare a dedicated jig for each work and further the need to change the jig. An operator can load the work at appropriate position and posture easily with good reproducibility.

### CROSS REFERENCE TO RELATED APPLICATION

The disclosure of Japanese Patent Application No. 2020-154400 filed on Sep. 15, 2020 including specification, drawings and claims is incorporated herein by reference in its entirety.

### BACKGROUND OF THE INVENTION

### 1. Field of the Invention

The present invention relates to a work receiving apparatus for receiving a work which is loaded from the outside, and more particularly to a technique for supporting a load operation of the work, which is performed by an operator.

### 2. Description of the Related Art

There is a case, for example, where for the purpose of inspecting a mechanical component, or the like, holding an inspection target (work) with a predetermined posture at a predetermined position is required. In such a case, it is general that the posture of the work is maintained to be constant by preparing a jig in accordance with the shape of the work. Further, after loading of the work, an alignment process for correcting the posture of the work is sometimes performed.

In an inspection apparatus disclosed in JP2018-205197A (Patent Literature 1), for example, a work which is an inspection target is held by a work table including a chuck mechanism adapted to the shape thereof.

A work handled in such an apparatus can have any one of various shapes. In the inspection apparatus disclosed in Patent Literature 1, a dedicated chuck mechanism in accordance with the shape of the work is needed. For this reason, in order to handle a plurality of kinds of works, a plurality of kinds of chuck mechanisms in accordance therewith need to be prepared.

From these problems, a technique which makes it possible to be adapted to works having various shapes and moreover to quickly respond to a change of the shape of the work or the placement posture thereof is required. For example, it is desired to provide a support function which makes it possible for an operator to easily grasp appropriate position and posture of a work when the work is loaded into an apparatus. Such a technique, however, has not been put to practical use yet.

### SUMMARY OF THE INVENTION

The present invention provides a technique which makes it possible for an operator to load the work at appropriate position and posture easily with good reproducibility.

One aspect of the present invention, to achieve the above-described object, is directed to a work receiving apparatus which includes a stage having an upper surface which serves as a placement surface on which a work having a predetermined shape can be placed, and a projection part provided above the placement surface, for projecting a guide image on the placement surface, which guides a placement position of the work on the placement surface. In the work receiving apparatus, the guide image includes an image corresponding to a shape of the work and an appropriate posture thereof on the placement surface.

Further, another aspect of the present invention, to achieve the above-described object, is directed to a placement support method for supporting an operation of placing a work having a predetermined shape on a predetermined placement surface, which includes acquiring information for specifying the work to be placed on the placement surface and projecting a guide image on the placement surface by a projection part provided above a position of the placement surface. The guide image includes an image corresponding to a shape of the work and an appropriate posture thereof on the placement surface.

In the present invention having such a configuration, the appropriate position and posture of the work on the placement surface are indicated by the guide image. An operator can thereby place the work at appropriate position and posture easily with good reproducibility by placing the work in conformity with the guide image. The guide image is determined in accordance with the shape of the work and the appropriate posture thereof. For this reason, when the kind of work or the posture thereof is changed, only the content of the guide image has to be changed. Therefore, according to the present invention, it is not necessary to prepare a dedicated jig or change the jig, and it is possible for an operator to place a work at appropriate position and posture easily with good reproducibility.

Further, one aspect of a work transport apparatus in according to the present invention includes the above-described work receiving apparatus and a transport part for transporting the work by moving the placement surface. The projection part is provided above a position of the placement surface at the time when the work is placed, among a moving path of the placement surface.

Furthermore, one aspect of an inspection apparatus according to the present invention includes the above-described work transport apparatus and an inspection part for imaging and inspecting the work which is transported to a predetermined inspection position by the transport part.

Moreover, one aspect of an inspection method according to the present invention includes receiving the work to be placed on the placement surface while performing the above-described placement support method, imaging the work placed on the placement surface, and inspecting the work on the basis of a captured image.

By these inventions, since the work can be placed at appropriate position and posture with good reproducibility, it is possible to favorably perform transport and inspection of the work thereafter.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a plan view schematically showing an overall configuration of an inspection system equipped with one embodiment of a work receiving apparatus according to the present invention.

FIG. 2 is a drawing showing an exemplary appearance shape of the work.

FIG. 3 is a trihedral figure exemplarily showing a posture of the work on the stage.

FIG. 4 is a block diagram showing a main electrical configuration of the inspection system.

FIGS. 5A to 5C are drawings showing an example of the guide image.

FIG. 6 is a flowchart showing an operation of the inspection system.

FIG. 7 is a drawing showing a variation of the inspection system.

FIG. 8 is a flowchart showing an operation in the variation.

### DETAILED DESCRIPTION OF THE PREFERRED EMBODIMENTS

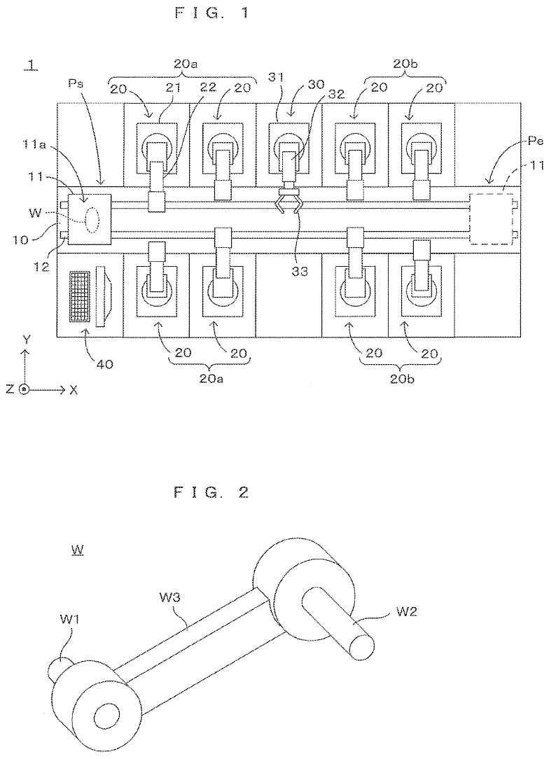

FIG. 1 is a plan view schematically showing an overall configuration of an inspection system equipped with one embodiment of a work receiving apparatus according to the present invention. This inspection system 1 is used, for example, for performing an appearance inspection of a mechanical component. For uniformly showing directions in the following figures, set is an XYZ rectangular coordinate system as shown in FIG. 1. Herein, an XY plane represents a horizontal plane and a Z direction represents a vertical direction.

The inspection system 1 includes a conveyor apparatus 10. The conveyor apparatus 10 includes a stage 11 for placing thereon a work W which is an inspection target and a transport mechanism 12 for transporting the work W by moving the stage 11 in an X direction. An upper surface of the stage 11 serves as a horizontal placement surface 11a. The work W is loaded from an end portion on a (−X) side (the left side of this figure) of the inspection system 1, transported in a (+X) direction, and finally unloaded from an end portion on a (+X) side (the right side of this figure) of the inspection system 1.

Specifically, a position (position Ps indicated by a solid line in this figure) where the stage 11 is on the most (−X) side within a movable range thereof in the conveyor apparatus 10 is a “transport start position”. The stage 11 receives the work W from the outside while being positioned at this transport start position. The work W is carried in by an operator and placed on the stage 11. With on operation of the transport mechanism 12, the stage 11 is moved in the (+X) direction and finally reaches a “transport end position” (position Pe indicated by a broken line in this figure) on the most (+X) side within the movable range thereof in the conveyor apparatus 10. After the stage 11 is positioned at the transport end position, the work W is unloaded to the outside by the operator.

The work W is transported while being placed on the stage 11 which is moved thus. Along a transport path of the work W, a plurality of inspection robots 20 are arranged. Each of the inspection robots 20 includes a lighting means and an inspection camera which are not shown, at a tip of an articulated arm 22 which is movable to and fro in each direction with a base part 21 as a starting point. The inspection robot 20 images the work W which is transported while being placed on the stage 11, inspects an appearance of the work W on the basis of the captured image, and detects any damage, chip, or the like thereof. The structure and operation of such an inspection robot are well known and a specific aspect of this inspection is not particularly restricted in the present invention. For this reason, description of the structure and operation of the inspection robot 20 will be omitted herein.

A reverse robot 30 is provided at almost the center of the transport path in the X direction. The reverse robot 30 includes a hand 33 capable of holding the work W at a tip of an articulated arm 32 which is movable in each direction with a base part 31 as a starting point. The reverse robot 30 holds the work W on the stage 11, which is transported, reverses the orientation thereof in an up-and-down direction, and places the work W on the stage 11 again. In other words, the work W is reversed in the up-and-down direction by the reverse robot 30.

Among the plurality of inspection robots 20, an inspection robot 20a which is disposed on the (−X) side from the reverse robot 30, in other words, on the upstream side in a work transport direction, inspects an upper surface side of the work W placed on the stage 11 by the operator. Though a lower surface side thereof is not inspected at that time, the lower surface side thereof can be inspected by an inspection robot 20b which is disposed on the (+X) side from the reverse robot 30, in other words, on the downstream side in the work transport direction, after the reverse robot 30 reverses the work W. Both surfaces of the work W are thereby inspected.

In addition to these constituents, the inspection system 1 includes a terminal device 40 used by the operator, for operating each constituent element of the inspection system 1. The inspection system 1 operates in accordance with any one of various operation instruction inputs to the terminal device 40 by the operator. Further, there may be a configuration where the conveyor apparatus 10 includes a plurality of stages 11 and the works W which are placed on the stages 11, respectively, are sequentially processed.

The work W to be inspected by the inspection system 1 is not particularly restricted. Various articles which have sizes allowed to be placed on the stage 11 and can be loaded on the stage 11 by a manual operation of the operator can serve as the work W. For example, various metal components manufactured by forging, casting, cutting, press working (stamping), or the like, plastic products manufactured by injection molding, and the like are suitable as the work W.

FIG. 2 is a drawing showing an exemplary appearance shape of the work. The work W shown in FIG. 2 is, for example, a kind of mechanical component like a crank arm used for a crank mechanism of a prime mover (motor) or a power transmission device. This work W has a structure in which shaft parts W1 and W2 whose central axes are in parallel with each other and offset each other and an arm part W3 for coupling these shaft parts are integrally formed. Hereinafter, description will be made by taking a case where the work W has such a shape, as an example. Further, it is assumed herein that the length of the shaft part W2 is longer than that of the shaft part W1.

The shape of the work is not limited to this but arbitrary, but it is assumed that the shape of the work serving as an inspection target of the inspection system 1 and the posture that the work should take one the stage 11 are known in advance.

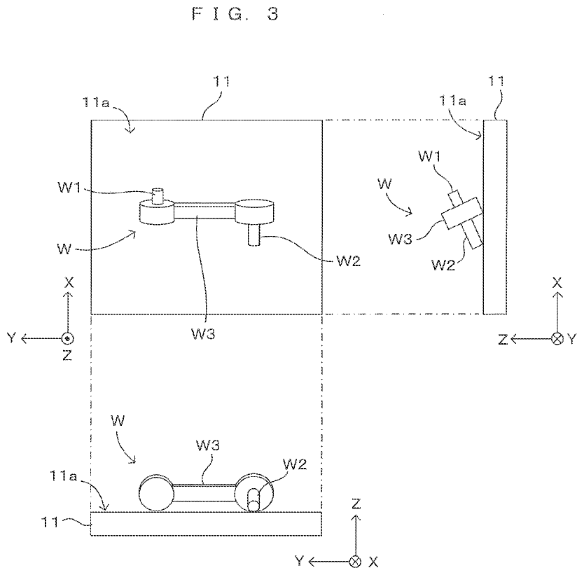

FIG. 3 is a trihedral figure exemplarily showing a posture of the work on the stage. In a case where the work W is placed on the stage 11 and then imaged and inspected, it is necessary that the work W should be placed on the stage 11 with appropriate posture at appropriate position. When the work W has a complicated three-dimensional shape, the work W can take various postures on the stage 11. FIG. 3 illustrates a state where the work W having such a shape as shown in FIG. 2 is placed on the stage 11 at appropriate position and posture.

When the work W is placed on the stage 11 by the manual operation of the operator, it is necessary that the work W should be placed at such position and posture as shown in FIG. 3 appropriately with good reproducibility. It is inevitable, however, that the placement operation by the operator causes variation. In the present embodiment, by supporting the placement operation of the work W performed by the operator in the following manner, the work W can be placed on the stage 11 at appropriate position and posture with good reproducibility.

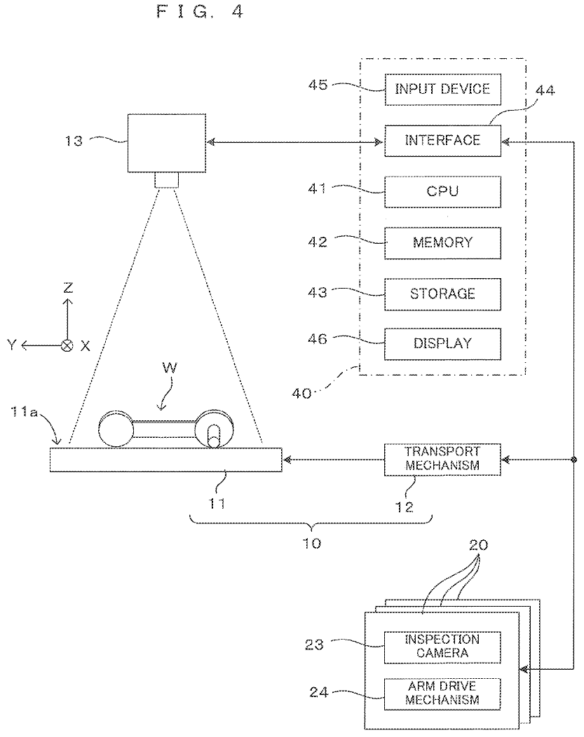

FIG. 4 is a block diagram showing a main electrical configuration of the inspection system. As the terminal device 40 of this inspection system 1, a computer device having a general-type hardware configuration can be applied. Specifically, the terminal device 40 includes a CPU (Central Processing Unit) 41, a memory 42, a storage 43, an interface 44, and the like. The CPU 41 executes a control program prepared in advance, to thereby perform various processings such as later-described operations or the like. The memory 42 stores therein various data generated in the course of the processings, in the short term. The storage 43 stores therein data in a term longer than that of the memory 42. For example, the control program to be executed by the CPU 41, original image data, data obtained after image processing and the like are stored in the storage 43.

The interface 44 performs communication with the outside. More specifically, the interface 44 has a function for performing data communication with an external device via a telecommunication line and another function for receiving an operation input from a user through an appropriate input device 45 such as a mouse, a keyboard, or the like. Further, a display device 46 has a display screen such as a liquid crystal display panel and displays thereon various images and/or text information for notification to its user.

Further, the terminal device 40 gives a control command to the transport mechanism 12 and the inspection robot 20 through the interface 44, to thereby control these constituents. Specifically, the transport mechanism 12 operates in accordance with the control command from the terminal device 40, to thereby perform the transport of the work W. Further, an inspection camera 23 and an arm drive mechanism 24 provided on the inspection robot 20 operate in accordance with the control command from the terminal device 40, and the inspection robot 20 thereby performs inspection of the work W.

Furthermore, in the conveyor apparatus 10 of this inspection system 1, a projector 13 is disposed with an outgoing direction of light, facing downward, above the stage 11 positioned at the transport start position Ps. The projector 13 is capable of performing enlarged projection, and it is desirable that a projection range on the upper surface (placement surface 11a) of the stage 11 should cover most of the stage 11, including a center portion thereof. The dotted line in FIG. 4 schematically indicates a range in which the light emitted from the projector 13 is spread.

The projector 13 is controlled by the terminal device 40 and projects an image corresponding to an image signal given from the terminal device 40, onto the upper surface 11a of the stage 11. This image serves as the guide image which guides the position and posture at the time when the operator places the work W on the stage 11. In other words, when the operator loads the work W in, with reference to the guide image displayed on the stage 11, the operator can place the work W on the stage 11 with appropriate posture at appropriate position.

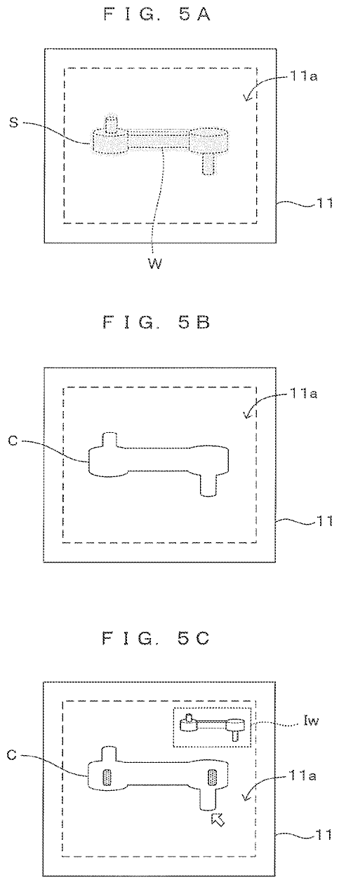

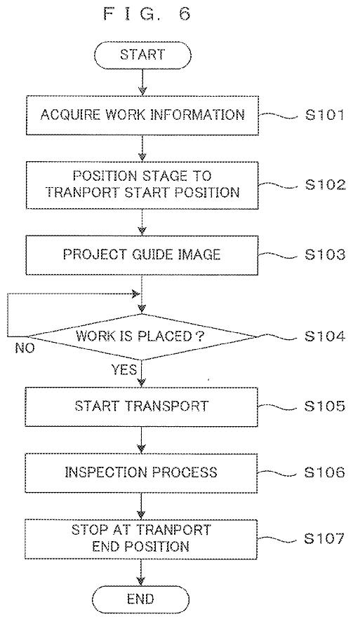

FIGS. 5A to 5C are drawings showing an example of the guide image. In FIGS. 5A to 5C, the broken line indicates the projection range of the projector 13. As a first example of the guide image, it can be thought that the guide image includes an actual size image (a photo or a graphic image) of the work W placed on the stage 11 with appropriate posture at appropriate position. In this case, the work W has only to be so placed as to be adapted to the actual size image displayed on the stage 11.

There is a case, however, where it becomes difficult to grasp the appropriate position of the work W on the stage 11 since the projected image overlaps the actual work W when the work W is loaded, in other words, the light from the projector 13 is shaded by the work W. Further, in the case of the work W having a complicated three-dimensional shape, the three-dimensional shape of the actual work and the shape of the displayed two-dimensional image, which are seen by the operator, do not always coincide with each other, and it thereby sometimes becomes difficult to grasp the appropriate posture.

A second example of the guide image, which can solve this problem, will be described. In this example, the shadow of the work W, which is formed on the stage 11 by the light emitted from the projector 13 is used.

An exemplary case where the work W is placed on the stage 11 with appropriate posture at appropriate position and the projector 13 projects an image which corresponds to a white solid image on the stage 11 is considered. At that time, the projector 13 serves as an illumination light source which illuminates the work W on the stage 11 with white light. Then, as shown in FIG. 5A, the work W on the stage 11 blocks the illumination light and a shadow S of the work W appears on the stage 11. Since the projector 13 performs enlarged projection, it is thought that the shadow S at that time is slightly larger than an image generated when the work W is projected on the stage 11 with an actual size from directly above.

Then, the guide image is generated to be an image indicating the position and the shape of the shadow S formed by the work W placed at appropriate position and posture, for example, representing a contour C thereof, as shown in FIG. 5B. The image of the work W, having an actual size, is shaded by placing the work W on the stage 11, but at least part of the contour C of the shadow is not blocked and projected on the stage 11. Therefore, the operator has only to place the work W so that the shadow formed on the placement surface 11a of the stage 11 by the work W coincides with the displayed contour C. The work W is thereby placed on the stage 11 with appropriate posture at appropriate position, with good reproducibility.

No matter how complicated the three-dimensional shape of the work W is, as long as the work W is placed with appropriate posture at appropriate position, the shadow formed on the stage 11 is uniquely determined in a relation with the illumination light. Further, when the stage 11 is flat, the shadow is naturally two-dimensional. Therefore, it is possible to show the appropriate position and posture of the work W with the two-dimensional figure displayed on the stage 11.

Further, there is a case where it is difficult to know what posture the work W should take when placed, only from the image simply representing the position (contour) of the shadow. From this point, it is preferable that an image of the work W representing a proper posture should be also displayed. For example, a guide image in which an image of the work W having an actual size is superimposed on a contour image shown in FIG. 5B can be used. Further, as shown in FIG. 5C, an image Iw of the work W may be displayed at a position near a peripheral portion of the stage 11, where the image is hard to be shaded by the work W or the body of the operator in the load operation of the work W. In these cases, the image of the work W does not always need to have an actual size.

Furthermore, the guide image may include information serving as a clue to be used when the operator places the work W. In a case, for example, where the work W includes a characteristic portion which is clearly different in appearance feature from other portions, such as a protruding portion, a hole, an identification mark, or the like, a marker which explicitly indicates a position of the characteristic portion can be added as visual information. An arrow mark shown in FIG. 5C, for example, indicates the position of the longer shaft part W2 in the work W shown in FIG. 2. Further, a hatched region in FIG. 5C represents a portion of the work W which is positioned at the highest position when the work W is placed with appropriate posture.

By checking such information before loading of the work W, the operator can grasp in advance what posture the work W should take when placed on the stage 11. Then, by adjusting the position of the work W so that the shadow formed on the stage 11 by the work W can coincide with the position indicated by the guide image, the work W can be placed with appropriate posture at appropriate position.

In a manufacturing premise requiring high-mix low-volume production (flexible manufacturing system), the kind of the work W to be inspected is changed frequently. Further, there may be a case where the shape of the work W is not changed but the posture of the work W on the stage 11 is changed in accordance with the purpose of the inspection. In a case where positioning of the work is performed by using a dedicated jig or chuck, it becomes necessary to change the jig or produce a new jig every time when such a model change is made. Furthermore, also in the case where the marking for positioning is given on the stage 11, it is necessary to rewrite the marking.

In contrast to this, in an exemplary case where the guide image is displayed from the projector 13 disposed above the stage 11 as described above, it is possible to immediately respond to the model change only by changing the content of the image to be outputted from the projector 13. When guide images corresponding to various works are prepared in advance and stored in the storage 43 of the terminal device 40, it is possible to change the guide image by selectively giving image data in accordance with the work to the projector from the terminal device 40.

Generation of the guide image can be performed, for example, in the following manner. First, the work W is placed on the stage 11 with appropriate posture at appropriate position. Further, an appropriate application which makes it possible for the terminal device 40 to generate an image is executed. The generated image is displayed on the stage 11 by the projector 13. When the operator performs drawing on the application in this state, the operator can generate the guide image while checking the image displayed on the stage 11 and the actual work W. The generated image is registered as the guide image corresponding to the work W and stored into the storage 43.

FIG. 6 is a flowchart showing an operation of the inspection system. More specifically, this flowchart shows the operation of the inspection system 1 from the loading of the work W to be inspected into the inspection system 1 until the work W is unloaded after being subjected to a predetermined inspection process. This operation is achieved when the CPU 41 executes the control program stored in the storage 43 in advance, to thereby cause the device constituents to perform predetermined operations. Further, it is assumed that the respective guide images corresponding to the plurality of kinds of works are generated in advance and stored in the storage 43.

Prior to start of the inspection, work information for specifying the kind of work W to be inspected and the posture thereof is acquired (Step S101). This work information is inputted into the terminal device 40 by the operator, for example.

Subsequently, the stage 11 is positioned at the transport start position Ps (Step S102), and the guide image which is selected on the basis of the work information is projected on the upper surface (placement surface 11a) of the stage 11 (Step S103). In this state, the process waits until the operator completes the placement operation of the work W (Step S104). If the operator gives an operation input indicating the completion of the operation to the terminal device 40 after the operation is completed, for example, it is possible to determine, with the input, that the placement is completed.

After placement of the work W is completed (“Yes” in Step S104), the conveyor apparatus 10 starts moving the stage 11, to thereby start transport of the work W (Step S105). At a timing when the work W passes near each inspection robot 20, each inspection robot 20 performs an inspection process (Step S106). Contents of the inspection process are arbitrary, and description thereof will be omitted herein.

After the inspection process is finished, when the stage 11 is moved and reaches the transport end position Pe, the transport is stopped (Step S107). The work W after the inspection is unloaded to the outside by the operator. By repeating the above-described processes, it is possible to sequentially perform the inspection process on the plurality of works. In a case, however, where the kind of work and the posture thereof are not changed, Step S101 can be omitted.

Thus, the present embodiment is the inspection system for receiving the work loaded from the outside and performing a predetermined inspection thereon. In order to perform the loading of the work W with appropriate posture at appropriate position with good reproducibility by the operator, the guide image is displayed on the stage 11 positioned at the transport start position. The guide image is projected from the projector 13 disposed above the stage 11 toward the upper surface of the stage 11.

The guide image includes an image corresponding to the shape of the shadow formed on the upper surface of the stage 11 by shading the light emitted from the projector 13 with the work W. For this reason, when the work W is placed so that the shadow formed on the stage 11 by the work W coincides with the guide image, the work W is placed with appropriate posture at appropriate position. The placement operation thereby becomes easier and the reproducibility is improved. With the enlarged projection function of the projector 13, the shadow of the work W becomes larger than an actual plane size of the work W to some degree. For this reason, it is avoided that the guide image to be projected on the stage 11 is completely blocked by the work W. It is possible to add various information to the guide image for supporting the placement operation by the operator.

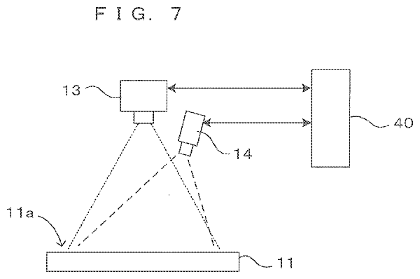

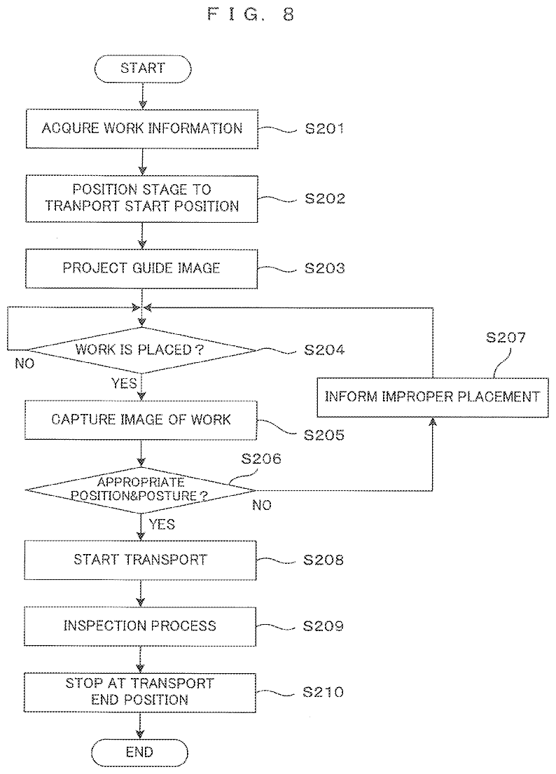

Next, with reference to FIGS. 7 and 8, a variation of the above-described inspection system 1 will be described. In this variation, a function for checking the position and posture of the work W placed by the operator is added to the above-described inspection system 1. Further, since the system configuration except the following points is the same as that of the above-described embodiment, the constituent elements identical to those in the present embodiment are represented by the same reference signs and detailed description thereof will be omitted.

FIG. 7 is a drawing showing a variation of the inspection system. Further, FIG. 8 is a flowchart showing an operation in the variation. As shown in FIG. 7, in the conveyor apparatus of this variation, in addition to the projector 13, an alignment camera 14 is disposed above the stage 11 at the time when the stage 11 is positioned at the transport start position Ps. The imaging visual field of the alignment camera 14 covers almost the entire of the upper surface of the stage 11, as indicated by the broken line in this figure. The alignment camera 14 is connected to the terminal device 40.

The operation of this variation is as follows. As shown in FIG. 8, also in this variation, like in the above-described embodiment, first, work information is acquired (Step S201), and a guide image in accordance with the work information is projected on the stage 11 positioned at the transport start position Ps (Steps S202 and S203). After the operator completes the placement operation of the work W (Step S204), the alignment camera 14 images the work W on the stage 11 (Step S205). At that time, it is preferable that the guide image should not be displayed.

An image in the state that the work W is placed with appropriate posture at appropriate position is stored in the storage 43 in advance as a reference image. Therefore, by comparison between the captured image and the reference image in the image processing, it is possible to determine whether or not the placement operation is performed appropriately. When the work W is placed appropriately (“Yes” in Step S206), the transport and inspection of the work is performed (Steps S208 to S210).

On the other hand, when there is a large difference between the captured image and the reference image, it is determined that at least one of the position and the posture of the work W is inappropriate. In this case (“No” in Step S206), improper placement is informed with screen display or alarm sound to the operator (Step S207), and the process goes back to Step S204 and waits for the operator to place the work W again. It is thereby possible to avoid any inspection error caused by performing the inspection on the work W in a state where the work W is placed at inappropriate position. Further, it is possible to reduce the variation in the placement operation by notifying the allowable degree of positional difference to the operator.

In such a configuration where the alignment camera 14 is additionally provided, it is possible to utilize the alignment camera 14 also for generation of the guide image. Specifically, the work W which is placed on the stage 11 in advance with appropriate posture at appropriate position is imaged by the alignment camera 14, and the captured image is superimposedly displayed on an edit image in an image creation application opened in the terminal device 40. Then, the operator can generate the guide image while superimposing the guide image on the displayed image. When the operator draws a linework by tracing the displayed shadow of the work W, for example, it is possible to easily generate the guide image representing the contour of the shadow. Further, part of the display image may be cut out and arranged on the guide image.

As described above, in the above-described embodiment and the variation thereof, the stage 11 and the projector 13 serve as the “stage” and the “projection part” of the present invention, respectively, and these elements constitute the “work receiving apparatus” of the present invention. Further, the terminal device 40, particularly the storage 43, serves as the “storage part” in the work receiving apparatus of the present invention. Furthermore, the alignment camera 14 and the terminal device 40 (the CPU 41 above all) serve as the “imaging part” and the “determination part” of the present invention, respectively.

Further, the conveyor apparatus 10 including the work receiving apparatus which includes the above-described constituent elements and the transport mechanism 12 serves as the “work transport apparatus” of the present invention, and the transport mechanism 12 corresponds to the “transport part”. Furthermore, the inspection system 1 corresponds to the “inspection apparatus” of the present invention, and the inspection robot 20 serves as the “inspection part” of the present invention.

Further, the present invention is not limited to the above-described embodiment, and various modifications of the invention other than those described above are possible without departing from the scope of the invention. In the above-described embodiment, for example, the projector 13 disposed above the stage 11 which is positioned at the transport start position Ps projects the guide image on the stage 11. The “projection part” of the present invention, however, is not limited to such a projector system as described above. For example, the projection part may display the guide image by laser scanning. In this case, in order to use the shadow of the work, which is formed on the stage, it is effective to separately provide an illumination light source for epi-illumination on the work. In terms of forming the shadow which is larger than the actual size of the work, for example, an illumination light source which is substantially regarded as a point light source is effective.

Further, in the guide image of the above-described embodiment, the information corresponding to the shadow of the work W on the stage 11 is combined with an image of the work itself or other reference information. All these pieces of information, however, do not always need to be combined, but each piece of information may be solely displayed.

Furthermore, in the above-described embodiment, the work W is placed on the stage 11 having a flat upper surface. There may be a configuration, however, for supporting an appropriate placement operation by combining the guide image with a configuration for specifying the position and posture of the work, such as an exemplary configuration in which a jig having a certain level of general versatility is provided on the stage, or the like. Further, in the above-described embodiment, the conveyor apparatus 10 includes the stage 11 and the transport mechanism 12, but the “work transport apparatus” in accordance with the present invention may be a so-called belt conveyance apparatus having a configuration in which the work is placed on a belt of a belt conveyor.

Furthermore, in the inspection system 1 of the above-described embodiment, specification of the kind of work W to be inspected and generation of the guide image are performed when the operator operates the terminal device 40 in the system. There may be a configuration, however, where these pieces of information are given from an external device via a communication line. Further, a terminal for editing the guide image and a control device for controlling the operation of the inspection system 1 may be provided as separate units. In this case, the “storage part” for storing therein the guide image may be provided in the control device on the inspection system side. Furthermore, in the above-described embodiment, the transport mechanism 12 and the inspection robot 20 are controlled by the same terminal device 40. However, a control terminal for the transport mechanism 12 and that for the inspection robot 20 may be provided separately.

Further, in the above-described embodiment, the position of the shadow S formed on the stage 11 by shading the illumination light from the projector 13 with the work W is indicated by the guide image representing the contour of the shadow. By separately providing an illumination light source other than the projector 13, however, the position of the shadow of the work W, which is formed on the stage 11 by the illumination light from the illumination light source, may be projected as the guide image by the projector 13.

As the specific embodiment has been illustrated and described above, in the present invention, for example, the guide image can include an image representing the position of the shadow formed on the placement surface by the work. It is thought that the shadow formed on the placement surface by the work having a three-dimensional shape is not completely blocked (shaded) by the work unless the work has a special shape. For this reason, by using the guide image corresponding to the shadow of the work, it becomes possible for the operator to perform a placement operation without being hindered by the blocking with the work.

Further, for example, the guide image may include an image of the work at the time when the work with appropriate posture is viewed from the above. Furthermore, for example, the guide image may include a marker indicating the position of the characteristic portion having an appearance feature different from that of the other portions in the work. With such a configuration, the operator can check the appropriate posture of the work before placing the work.

Further, in the present invention, the projection part can have, for example, a projector capable of performing enlarged projection of an image. With such a configuration, since the content of the guide image can be determined by using image data to be given to the projector, it is possible to easily respond to the change of the work. In the case of using the guide image representing the shadow of the work, particularly, since the shadow becomes larger than the work by the enlarged projection function, it is possible to reduce the effect of the blocking of the guide image by the work.

Furthermore, for example, there may be a configuration where a storage part for storing therein a plurality of kinds of guide images which are different from one another in at least one of the kind of work and the posture thereof is further provided and the projection part selectively projects the plurality of kinds guide images. With such a configuration, by changing the guide image to be projected, it becomes possible to immediately respond to the change of the kind of work or the posture thereof.

Further, for example, the present invention may further include an imaging part for imaging the work placed on the placement surface and a determination part for determining the placement state of the work with respect to the placement surface based on an image captured by the imaging part. With such a configuration, since the position and posture of the work which is placed can be checked, it is possible to reduce failures or variation in the placement operation.

Furthermore, for example, in the stage, the placement surface may be a flat plane. With such a configuration, since the stage does not correspond to the shape of the specific work, it is possible to receive works having various shapes in a wide range. Further, since the guide image is projected on a flat surface, it is easy to visually recognize the guide image.

The present invention can be applied to a work receiving apparatus which receives a work loaded from the outside and an inspection apparatus for inspecting, for example, the work. More particularly, the present invention can be used as a technique for effectively supporting a load operation of the work, which is performed by the operator.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A work receiving apparatus, comprising:
a stage which includes an upper surface serving as a placement surface on which a work having a predetermined shape can be placed; and
a projection part which is provided above the placement surface and projects a guide image on the placement surface to guide a placement position of the work on the placement surface, wherein
the guide image includes an image corresponding to a shape and an appropriate posture of the work on the placement surface.

2. The work receiving apparatus according to claim 1, wherein the guide image includes an image which represents a position of a shadow formed on the placement surface by the work.

3. The work receiving apparatus according to claim 1, wherein the guide image includes an image of the work with appropriate posture viewed from above.

4. The work receiving apparatus according to claim 1, wherein the guide image includes a marker which indicates a position of a characteristic portion having an appearance feature different from other portion in the work.

5. The work receiving apparatus according to claim 1, wherein the projection part includes a projector which performs enlarged projection of an image.

6. The work receiving apparatus according to claim 1, further comprising a storage part which stores a plurality of kinds of guide images which are different from one another in at least one of the kind and the posture of the work, wherein
the projection part selectively projects the plurality of kinds of the guide images.

7. The work receiving apparatus according to claim 1, further comprising:
an imaging part which images the work placed on the placement surface; and
a determination part which determines a placement state of the work with respect to the placement surface based on an image captured by the imaging part.

8. The work receiving apparatus according to claim 1, wherein the placement surface is a flat plane.

9. A work transport apparatus, comprising:
the work receiving apparatus according to claim 1; and
a transport part which transports the work by moving the stage, wherein
the projection part is provided above a position of the stage where the stage receives the work among a moving path of the stage.

10. An inspection apparatus, comprising:
the work transport apparatus according to claim 9; and
an inspection part which images and inspects the work transported to a predetermined inspection position by the transport part.

11. A placement support method for supporting an operation of placing a work having a predetermined shape on a placement surface, the placement support method comprising:
acquiring information for specifying the work to be placed on the placement surface; and
projecting a guide image on the placement surface by a projection part provided above a position of the placement surface, wherein
the guide image includes an image corresponding to a shape and an appropriate posture of the work on the placement surface.

12. An inspection method, comprising:
receiving the work to be placed on the placement surface while performing the placement support method according to claim 11;
imaging the work placed on the placement surface; and
inspecting the work based on a captured image.
